(19) United States
(12) Patent Application Publication
(10) Pub. No.: US 2021/0074232 A1
(43) Pub. Date: Mar. 11, 2021

(54) HYBRID-MATRIX DISPLAY

(71) Applicant: eMagin Corporation, Hopewell Junction, NY (US)

(72) Inventor: Ihor WACYK, Hopewell Junction, NY (US)

(21) Appl. No.: 17/010,655

(22) Filed: Sep. 2, 2020

Related U.S. Application Data
(60) Provisional application No. 62/896,924, filed on Sep. 6, 2019.

(51) Int. Cl. G09G 3/36; G09G 3/00; G09G 3/3208

(52) U.S. Cl. CPC G09G 3/3648; G09G 3/3208; G09G 3/007; G09G 3/3622

(57) ABSTRACT

An integral imaging display system is provided including an orthogonal array of a plurality of displaylets, each displaylet used to form an elemental image, each displaylet comprising a passive matrix array of pixels, and each displaylet connected to a common data and address bus, the common data and address bus providing video information to each displaylet, in sequence, wherein each displaylet is driven actively.

### CROSS-REFERENCE TO RELATED APPLICATION

This application claims priority to U.S. Provisional Application Ser. No. 62/896,924, entitled Hybrid Matrix Display, filed on Sep. 6, 2019, pending, the complete specification of which is fully incorporated by reference herein.

### BACKGROUND OF THE INVENTION

This invention generally relates to a backplane architecture for a microdisplay aimed at viewing 3D content in a compact form-factor. It enables the implementation of a near-to-eye display system based on the integral-imaging concept. A planar display employing this invention will contain an array of elemental images and an array of microlenses to create an angular distribution of images, which, when focused by the eye, will create a sense of depth.

A conventional microdisplay is generally designed to display a 2D image that is formed in the plane of the display substrate. As shown in FIG. 1, displays of the prior art normally consist of a uniform array of contiguous pixels which form the viewing area, and the drivers which are used to program data into selected rows of pixels. Scan line drivers are used to sequentially select a single row of pixels, one at a time, and data line drivers are then used to program data into the selected pixels. In this way, the entire array of pixels is updated once per frame cycle. In a typical active-matrix organic light-emitting diode (AMOLED) microdisplay, the pixels consist of an orthogonal array of pixel circuits and light emitting organic light-emitting diode (OLED) diodes. As shown in FIG. 2, each pixel circuit contains a memory element (capacitor C) in order to store the data and to hold the image between refresh cycles. This allows high resolution pixel arrays to be built with efficient operation and long lifetime.

One limitation with the prior art microdisplay, as shown, for example, in FIGS. 1 and 2, is that the miniaturization of a pixel element is limited by the size of the associated pixel circuit, which is determined both by the number of transistor components it contains and the size of its storage capacitor. These components are built in a silicon substrate and must conform to the design rules set by the silicon foundry in which it is fabricated. Although silicon processes have generally scaled following Moore's law over the last few decades resulting in ever smaller device sizes, this has not applied to pixel circuits which must support the operating requirements of organic light-emitting diode (OLED) devices. Specifically, the operating voltages of OLED devices limit the ability to shrink design rules for transistors below the level that the physics of silicon will support. As a result, the minimum area of an OLED pixel element is currently at around 20 μm² or about 4.5 μm on a side.

A second limitation of a microdisplay of the prior art is the need for a substantial border area around the pixel array. As shown in FIG. 1, scan line driver and data line drivers are located outside of and in the same physical plane as the pixel array. That is because the circuits for the line drivers and pixels cannot be co-located in the same active area of the silicon substrate which contains only a single layer of transistors. As a result, the display chip requires hundreds of microns of border width around any pixel array to support the drive functions. Often, the border area of the microdisplay also includes additional functionality, such as data processing, timing control, as well as bond pads.

A new class of display has been of interest in recent years that is based on the integral imaging display concept as illustrated in FIGS. 3 and 4. This concept system enables a full 3D image to be displayed from a planar display device by spreading a 3D image array across a 2D display field. In this integral imaging display system, its viewing area is composed of an array of elemental images, where each elemental image is constructed as an individual 2D array of pixels. The display device is mated with a microlens array consisting of one lens for each elemental image. Together, each pair of elemental image and lens produces an angular distribution of light rays at each point which, when focused by the eye, produce a sense of depth. The spatial resolution of the integral-imaging display device corresponds to the number and pitch of elemental images, while the angular resolution (or depth resolution) depends on the resolution of the pixel array that forms each elemental image. Clearly, this display will require a much higher density of pixels to form an image with the same spatial resolution as a 2D display.

FIG. 4 depicts a typical configuration of an integral-imaging display device. The display device consists of the large array of elemental images, each of which is an individual high-resolution pixel array. A small gap (e.g., <50 μm) can be allowed between elemental images since these will be masked by the microlens array. It is desirable to use pixels with a pitch smaller than about 2 μm to minimize the area of each elemental image and thus increase the display spatial resolution. In addition, a small border area around the entire display chip (e.g., <150 μm) would allow such displays to be tiled in order to build very high resolution display systems. Today's display technology cannot achieve the requirements of both ultra-small pixel pitch and near borderless microdisplay chips.

### SUMMARY OF THE INVENTION

The proposed invention defines a method for driving and building a display to be used for implementing a near-to-eye integral-imaging system.

The present invention is directed to an integral imaging display system, including an orthogonal array of a plurality of displaylets, where each displaylet is used to form an elemental image. Each displaylet includes a passive matrix array of pixels, and each displaylet is connected to a common data and address bus where the common data and address bus provides video information to each displaylet, in sequence. Each displaylet is driven actively.

Each passive-matrix array of pixels may include an associated scan line driver and data line driver. Each passive-matrix pixel array may include OLED diodes arranged at the intersections of a set of horizontal conducting lines and vertical conducting lines. Each passive-matrix pixel array may have its drive and control functions located underneath the passive-matrix pixel array to provide for near borderless array spacing.

### BRIEF DESCRIPTION OF THE DRAWINGS

FIG. 1 is a simplified front view of a conventional, prior art microdisplay, illustrating pixel addressing architecture for a conventional.

FIG. 2 is a simplified, partial schematic view of a conventional, prior art OLED microdisplay, depicting organization of pixels.

FIG. 3 is a simplified, perspective view of a prior art illustration of an integral-imaging display.

FIG. 4 is front view of an example of a prior art configuration of an integral-imaging display device consisting of an array of elemental images.

FIG. 5 is a block diagram of an integral-imaging display system architecture in accordance with an exemplary embodiment of the present invention.

FIG. 6 is a block diagram of displaylet sub-system of the integral-imaging display device shown in FIG. 5.

FIG. 7 depicts a configuration for a passive-matrix OLED diode array that is used to form the viewing area of the elemental image of the integral imaging display device of FIG. 6.

FIG. 8 is a simplified front view of the physical layout of the display device of FIG. 6.

FIG. 9 depicts a comparison of physical layouts of a typical active-matrix pixel element and a passive-matrix pixel element.

FIG. 10 presents a timing diagram for the basic operation of a typical active-matrix microdisplay.

FIG. 11 depicts an exemplary timing diagram for the operation of the integral-imaging microdisplay device of FIG. 6.

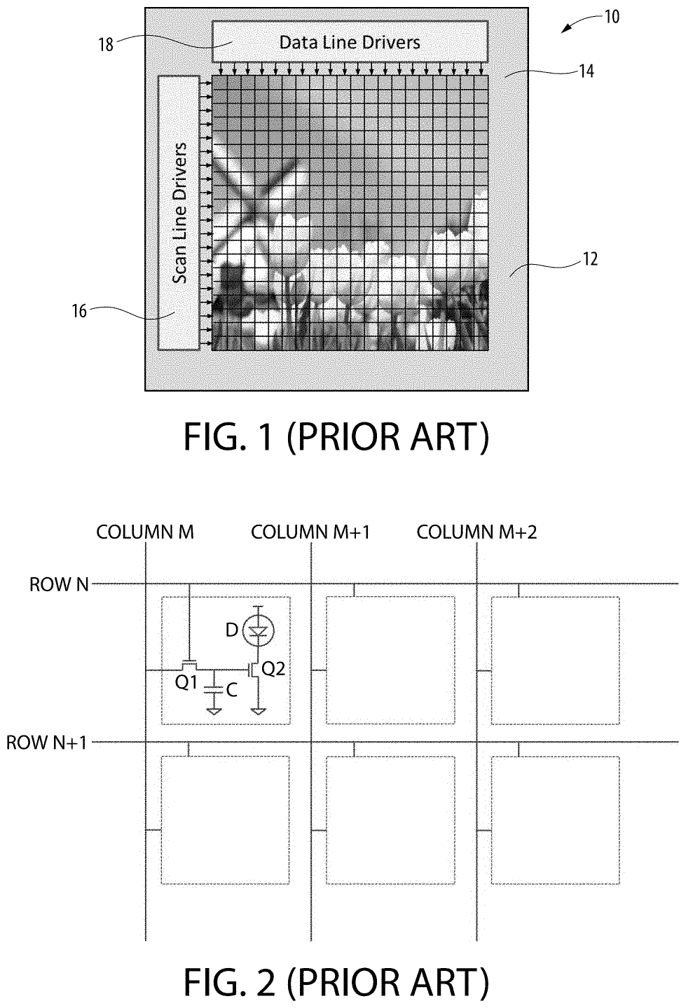

### DETAILED DESCRIPTION OF THE INVENTION

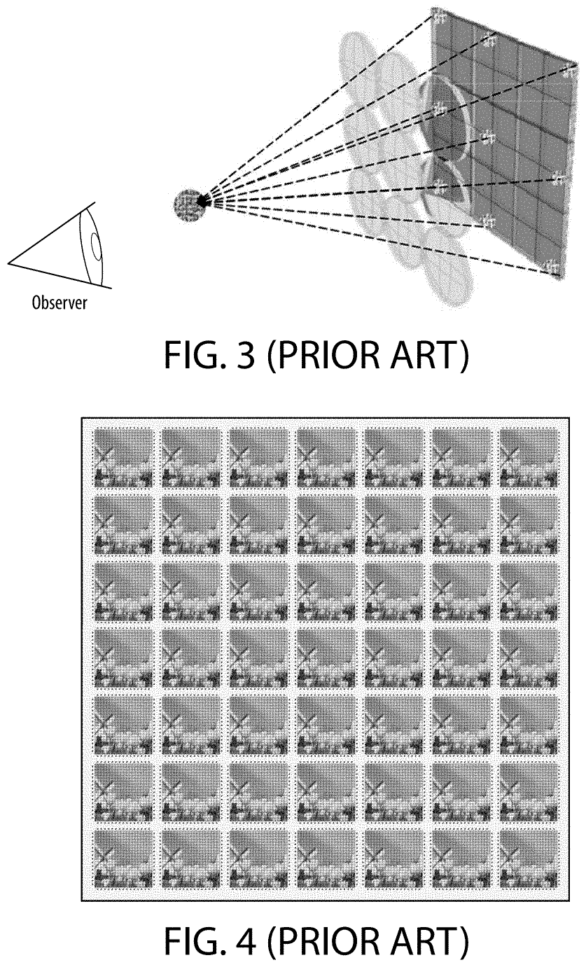

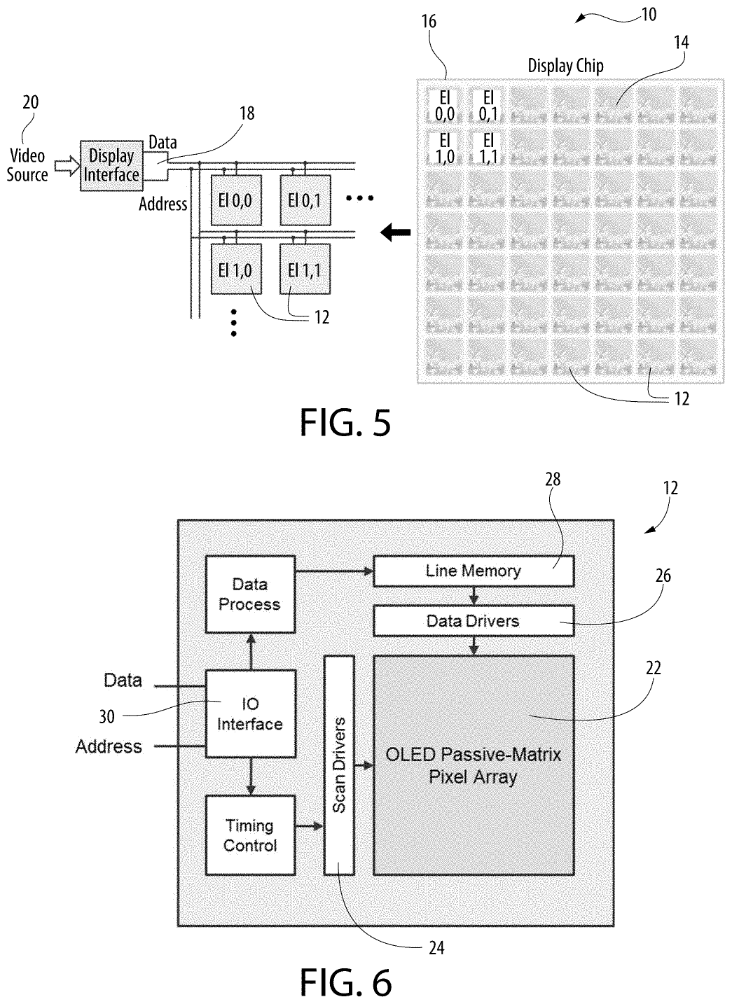

The present invention is directed to a display drive system that is suited to forming viewable 3D images without the need for complex optical components. As shown in FIG. 3 as described in the Background of the Invention, the integral-imaging concept requires the formation of an array of elemental images on the display chip. The proposed hybrid-matrix display architecture of the present invention that is designed to support this configuration is shown in FIG. 5. The figure depicts a block diagram of the integral-imaging display system 10 of the present invention. It consists of an orthogonal array of display fields, deemed “displaylets” 12 herein, which are used to form the elemental images 14 on a chip 16. All the displaylets 12 are self-contained mini-displays and are tied to a common data and address bus 18. The external video source 20 supplies video information through the common data bus 18 to drive each of the displaylets 12, in sequence, one at a time. The displaylets 12 are driven as passive-matrix arrays. Because the displaylets 12 within the display system 10 are driven actively, while the pixels within the displaylets 12 are driven passively, the overall display system 10 is considered to be operated in a novel hybrid-drive method that combines both active and passive schemes in the same display 10.

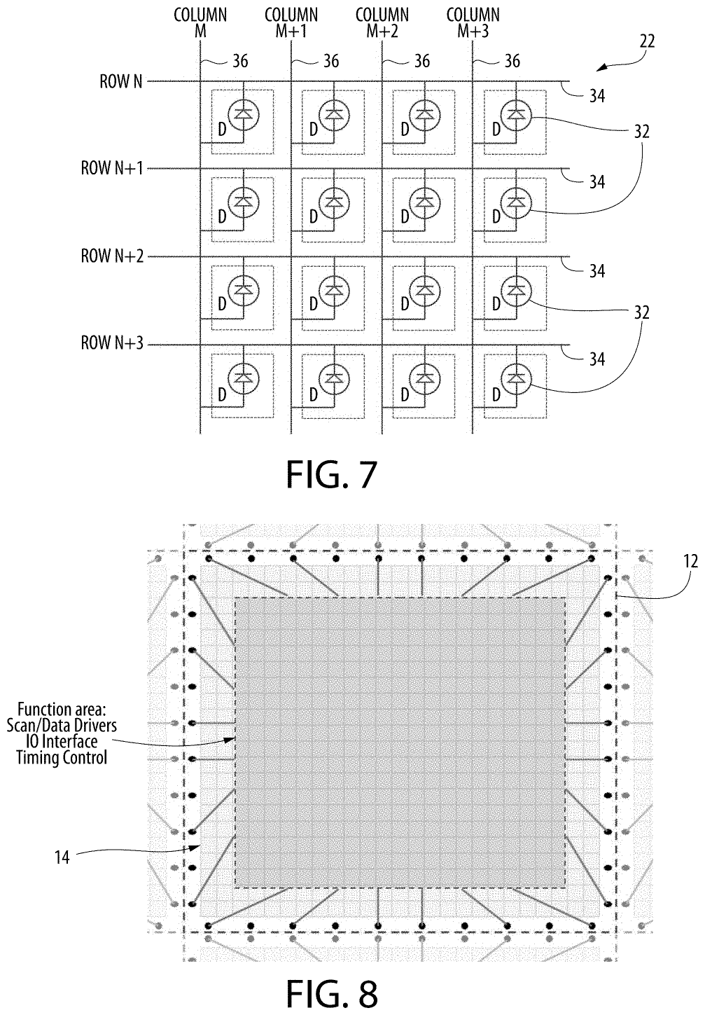

FIG. 6 depicts a functional block diagram of the displaylet 12 of the present system 10. The displaylet 12 consists of a passive-matrix array of pixels 22 and its associated scan line driver 24 and data line driver 26 as well as other support functions, including a line memory 28 and an interface 30 to the common data and address bus 18. As shown in FIG. 7, the passive-matrix pixel array 22 contained in a displaylet 12 consists of OLED diodes 32 arranged at the intersections of a set of horizontal conducting lines 34 and vertical conducting lines 36. The vertical conducting lines 36, which supply the pixel data signals, are formed in the top metal layer of the silicon wafer process. Standard vias are formed above the top wafer metal to provide connections to special metal pads which serve as bottom electrodes for the OLED diodes 32. The horizontal conducting lines 34 are formed in a transparent conductive layer which serves as the top electrode for the OLED diodes 32. This top conductive layer is patterned into a set of narrow horizontal lines. Since the passive pixel array 22 contains no active silicon devices and only column metal lines and vias, it allows the area underneath to be used for drive and control circuitry.

FIG. 8 is a top-view of the physical layout of the display chip showing the arrangement of components within a single displaylet 12. FIG. 8 illustrates how all the functional control circuits are located in the area underneath the pixel array 22, with only a small ring of standard silicon vias placed around the passive array for use as connections between the scan and data lines and the underlying control functions. Since the standard silicon vias are less than 1 micron in diameter, the border around each displaylet 12 can be quite small, and the displaylets 12 can be packed in very tightly. In addition, since the number of displaylets 12 in any particular display will be relatively small (<few hundred) there will be no significant global scan and data driver functionality. This means that the border area of the overall display can also be small, allowing displays to be tiled. In this case, through-silicon-vias along the border of the overall display will be needed to feed signals and power from below the display chip.

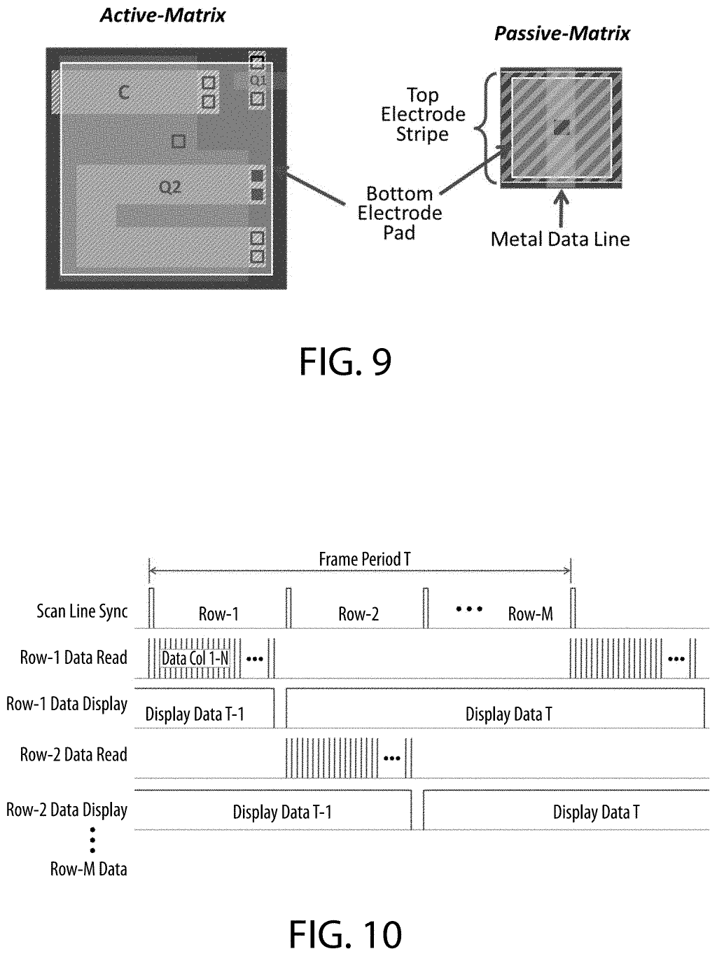

FIG. 9 compares the physical layout of a typical active-matrix pixel to a passive-matrix pixel element. The passive-matrix pixel layout is much smaller than the active-matrix version because it does not contain any active devices or storage capacitor. As a result, it is possible to build a much denser array of pixels in the passive-matrix version, which is particularly beneficial to creating a high-resolution array of elemental images.

A timing diagram for the operation of a conventional, prior art, display is depicted in FIG. 10. A frame period consists of a sequence of scan line periods which are equal to the number of rows in the array. Pixel data for an individual row is read in as a sequence of data bytes during the scan line period and are then used to program the selected row of pixels. Each row of data is programmed once during each frame period, in a sequence from top to bottom. After programming, the pixels will retain the data values throughout the frame period until the next programming cycle.

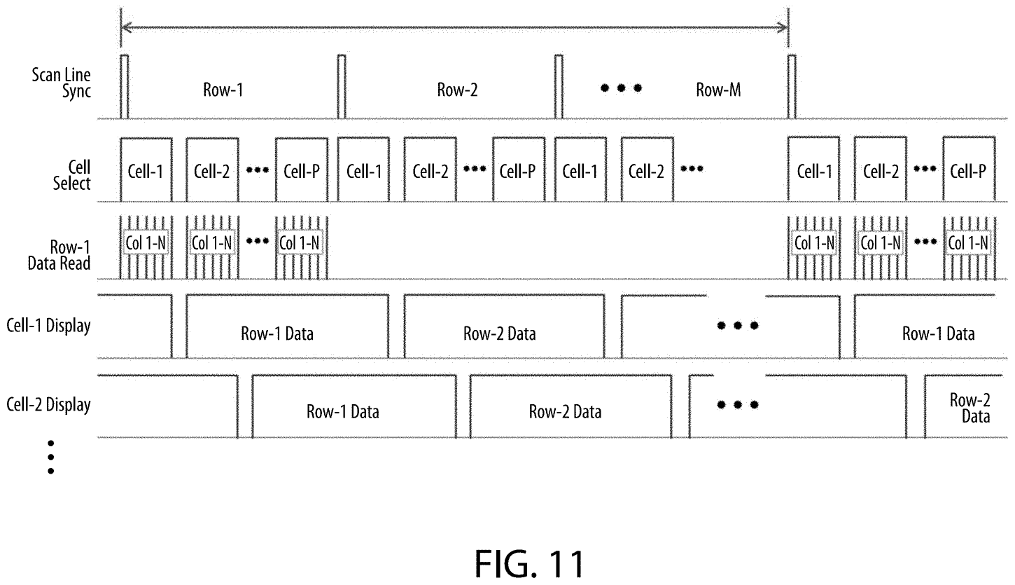

A timing diagram for the hybrid-matrix display system 10 of the present invention is shown in FIG. 11. In this case, a frame period is divided into a number of scan line periods which is equal to the number of rows in a displaylet 12. Pixel data for the selected row is read for all of the displaylets 12 in sequence during a scan line period. In this way, each row of a displaylet 12 is programmed once during a frame period. Since the displaylet arrays have no pixel storage capacitor, they can only display an image while being actively driven, which can be no longer in duration than a single scan line period. In fact, the actual programming time for a row of pixels in a displaylet is a small fraction of a scan line period, so the displaylet pixels would only be active for a very short time during each frame period. To correct for this problem, each displaylet contains at least one row of data memory. After programming, the displaylet memory allows the selected row of pixels to be driven for the full scan line period.

In contrast to a conventional active-matrix display, the pixels in the hybrid-matrix display system 10 can only be ON for a fraction of the total frame period. The maximum pixel ON-time as a fraction of a frame period (persistence) will be equal to the inverse of the number of independently-driven rows in a displaylet. For example, a displaylet with 200 rows that are driven one row at a time will have a persistence of 0.5%. On the other hand, the same display with two rows driven at a time (and 2 line memory) will have a persistence of 1%.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An integral imaging display system, comprising:
(a) an orthogonal array of a plurality of displaylets, each displaylet used to form an elemental image, each displaylet comprising a passive matrix array of pixels; and
(b) each displaylet connected to a common data and address bus, the common data and address bus providing video information to each displaylet, in sequence, wherein each displaylet is driven actively.

2. The integral imaging display system of claim 1, wherein each passive-matrix array of pixels includes an associated scan line driver and data line driver.

3. The integral imaging display system of claim 1, wherein each passive-matrix pixel array comprises OLED diodes arranged at the intersections of a set of horizontal conducting lines and vertical conducting lines.

4. The integral imaging display system of claim 1, wherein each passive-matrix pixel array has its drive and control functions located underneath the passive-matrix pixel array to provide for near borderless array spacing.
